(19) United States
(12) Patent Application Publication
(10) Pub. No.: US 2025/0218169 A1
(43) Pub. Date: Jul. 3, 2025

(54) NEURAL NETWORK ACCELERATION OF IMAGE PROCESSING

(71) Applicants: NUtech Ventures, Lincoln, NE (US); New Jersey Institute of Technology, Newark, NJ (US)

(72) Inventors: Arman Roohi, Lincoln, NE (US); Shaahin Angizi, Union City, NJ (US); Sepehr Tabrizchi, Lincoln, NE (US)

(21) Appl. No.: 19/004,020

(22) Filed: Dec. 27, 2024

Related U.S. Application Data
(60) Provisional application No. 63/615,622, filed on Dec. 28, 2023.

(51) Int. Cl. G06V 10/82; G06T 5/20

(52) U.S. Cl. CPC G06V 10/82; G06T 5/20; G06T 2207/20084

(57) ABSTRACT

Methods, systems, and apparatus, including computer programs encoded on computer storage media, for improving image processing. One of the methods includes obtaining, from a first set of pixels, a first set of pixel values at a first time; obtaining, from a second set of pixels, a second set of pixel values at a second time; determining a number of changed pixel values by comparing the first and second sets of pixel values; comparing the number of changed pixel values to a threshold value; determining whether an event has occurred using the comparison of the number of changed pixel values to the threshold value; and in response to determining the event has occurred, activating a third set of pixels, wherein the third set of pixels includes one or more pixels adjacent to the first and second set of pixels.

### CROSS-REFERENCE TO RELATED APPLICATION

This application claims the benefit of U.S. Provisional Application No. 63/615,622, filed Dec. 28, 2023, the contents of which are incorporated by reference herein.

### FEDERALLY SPONSORED RESEARCH OR DEVELOPMENT

This invention was made with government support under ECCS2216773 and 2216772 awarded by the National Science Foundation. The government has certain rights in the invention.

### BACKGROUND

Convolutional neural networks (CNNs) or other machine learning methods can be used to process image data. Processing generally requires computers to perform a series of calculations using image data as input.

### SUMMARY

This specification describes technologies for reducing power consumption of processing data, such as images. Techniques can include a parallel analog convolution-in-pixel scheme and reconfigurable filtering modes with filter pruning capabilities. Techniques can be included in processing systems to reduce power consumption of processing data, e.g., converting or processing data for neural network tasks.

In some implementations, the architecture includes an always-on intelligent visual perception architecture. For example, the architecture can detect an object, such as a moving object using a subset of activated pixels. In response to detecting the object, the architecture can switch from a low-power mode to a high-power object-detection mode, with more activated pixels, to capture and process one or more images. The architecture described results in significant reductions in power and delay while maintaining acceptable accuracy.

Data can be captured from always-on intelligent or self-powered visual perception systems, among other data sources. Analyzing data, e.g., using a backend or cloud processor, can be energy-intensive and can cause latency, resulting in a resource bottleneck and low-speeds. To achieve high accuracy and acceptable performance in visual systems, convolutional neural networks (CNNs) generally use large amounts of storage and numerous processing operations, making embedded edge devices with constrained energy budgets or hardware difficult.

This document describes, in part, an Approximate Convolution-in-Pixel Scheme for Neural Network Acceleration (AppCiP) architecture. The architecture can be used as a sensing and computing integration design to efficiently enable Artificial Intelligence (AI), e.g., on resource-limited sensing devices. The AppCiP architecture can be especially useful for edge devices with constrained energy budgets or hardware. The architecture can help replace extensive data transfer to and from a central computing system with edge processing of data to reduce the power consumption for data transferring or operation.

Capabilities of the architecture can include instant and reconfigurable red-green-blue (RGB) to grayscale conversion, highly parallel analog convolution-in-pixel, or realizing low-precision quinary weight neural networks. Features of the architecture can mitigate the overhead of analog-to-digital converters and analog buffers, leading to a reduction in power consumption and area overhead. In simulations, the architecture can achieve approximately three orders of magnitude higher efficiency on power consumption compared with existing designs over different CNN workloads. The architecture can reach a frame rate of 3000 and an efficiency of ˜4.12 Tera Operations per second per Watt (TOp/s/W). The performance accuracy of the architecture on different datasets such as Street View House Numbers (SVHN), Plant and Environmental Stress (Pest), Canadian Institute for Advanced Research-10 (CIFAR-10), Multispectral Hand Image Segmentation and Tracking (MHIST), and Center for Biometrics and Law Face detection (CBL Face detection) performs similar to less energy efficient architectures—e.g., using floating-point baseline

The architecture can include a low-power Processing-in-Pixel (PIP) scheme with event and object detection capabilities to help alleviate power costs of data conversion or transmission. The architecture can include two levels of approximations, including instant conversion of RGB inputs (three R, G, and B channels) to Grayscale (one channel) and analog convolution, enabling low-precision quantized neural networks to mitigate the overhead of analog buffers. In some cases, the architecture supports five different weights, that provide energy efficiency with comparable accuracy to the floating-point (FP) baseline.

In general, one innovative aspect of the subject matter described in this specification can be embodied in methods that include the actions of obtaining, from a first set of pixels, a first set of pixel values at a first time; obtaining, from a second set of pixels, a second set of pixel values at a second time; determining a number of changed pixel values by comparing the first and second sets of pixel values; comparing the number of changed pixel values to a threshold value; determining whether an event has occurred using the comparison of the number of changed pixel values to the threshold value; and in response to determining the event has occurred, activating a third set of pixels, wherein the third set of pixels includes one or more pixels adjacent to the first and second set of pixels. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In some implementations, for example, the first and second set of pixels are comprised of centroid pixels, wherein each of the centroid pixels are adjacent to pixels not included in the first or second set of pixels. In some implementations, the first and second set of pixels are the same. In some implementations, pixels of the first and second set of pixels include a sensor and one or more compute add-ons, wherein (i) each of the one or more compute add-ons include a plurality of transistors and (ii) the sensor includes a photodiode. In some implementations, photodiodes of the sensors in the pixels of the first and second set of pixels include activated photodiodes and non-activated photodiodes. In some implementations, the only activated photodiode detects radiation in a frequency range corresponding to the color green. In some implementations, the photodiodes include a red and blue photodiode that are non-activated. In some implementations, the plurality of transistors of the pixels are configured to generate multiple levels of current using voltage from a capacitor connected to the photodiode and a set of one or more weighted values. In some implementations, comparing the first and send sets of pixel values include: comparing a subset of one or more bits from one or more bits representing a first value of the first set of pixel values and a subset of one or more bits from one or more bits representing a second value of the second set of pixel values. In some implementations, comparing the subset of bits representing the first value and the subset of bits representing the second value includes: comparing three bits representing the first value and three bits representing the second value.

In general, one innovative aspect of the subject matter described in this specification can be embodied in methods that include the actions of obtaining values from a pixel array; generating, using a set of N filters, a first convolutional output by applying the set of N filters to a first set of the values from the pixel array; providing the first convolutional output to a set of two or more analog-to-digital converters; generating, using output of the two or more analog-to-digital converters, a first portion of an output feature map; generating, using the set of N filters, a second convolutional output by applying the set of N filters to a second set of the values from the pixel array; providing the second convolutional output to the set of two or more analog-to-digital converters; and generating, using output of the two or more analog-to-digital converters processing the second convolutional output, a second portion of the output feature map. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In some implementations, N is 3. In some implementations, the pixel array includes an array of 32 pixels by 32 pixels. In some implementations, the first portion of the output feature map is a row or column of the output feature map. In some implementations, the first portion of the output feature map and the second portion of the output feature map are separated by N-1 rows or columns. In some implementations, the first set of the values from the pixel array and the second set of the values from the pixel array are separated by N-1 rows or columns. In some implementations, the set of N filters include one or more coefficient matrices. In some implementations, the set of N filters include three 3×3 coefficient matrices.

In general, one innovative aspect of the subject matter described in this specification can be embodied in methods that include the actions of generating a first convolution output by performing, using a first set of coefficient matrices, convolution over a first set of values from a pixel array; identifying, using a first offset value, a second set of values from the pixel array; generating a second convolution output by performing, using the first set of coefficient matrices, convolution over the second set of values from the pixel array; identifying, using a second offset value, a third set of values from the pixel array, generating, using the first set of coefficient matrices, a second set of coefficient matrices; generating a third convolution output by performing, using the second set of coefficient matrices, convolution over the third set of values from the pixel array; and generating, using (i) the first convolution output, (ii) the second convolution output, and (iii) the third convolution output, an output feature map. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In some implementations, performing the convolution over the first set of values from the pixel array is performed in a single compute cycle.

In general, one innovative aspect of the subject matter described in this specification can be embodied in a system that includes a focal plane array; a group of one or more buffers connected to the focal plane array; the focal plane array comprising a plurality of pixels, wherein each pixel of the plurality of pixels includes a sensor and one or more compute add-ons, wherein (i) each of the one or more compute add-ons include a plurality of transistors and (ii) the sensor includes a photodiode; and wherein the plurality of transistors are configured to generate multiple levels of current using voltage from a capacitor connected to the photodiode and a set of one or more weighted values.

The technology described in this specification can be implemented so as to realize one or more of the following advantages. In some cases, image sensors can be placed in low access areas where cloud-based products can be unsustainable The processing architecture described in this document can be used in any processing scenario, such as processing for sensors placed in low access areas. The low energy consumption of the proposed techniques can be especially useful in monitoring applications—e.g., monitoring growth of crops in a field. Dual sensing capabilities of devices using the architecture described can reduce power consumption of the device and lengthen its life span, e.g., by reducing operation energy usage and data transfers.

Advantages can include one or more of reduced data transmission, enhanced privacy, enhanced security, improved system reliability, low latency, or real-time analytics. For example, implementations described can reduce data transmission by, e.g., processing data locally, a sensor can send only relevant or processed data, reducing an amount of data to be transmitted to a processor, e.g., central server. This can be particularly beneficial in systems with bandwidth limitations. Implementations described can enhanced privacy or security by, e.g., processing data locally—e.g., reducing a risk of intercepting sensitive data during transmission. This can be particularly important in applications involving personal data, e.g., smart home devices or healthcare monitors. Implementations described can improve system reliability, e.g., by processing data locally which can increase robustness by reducing dependency on continuous network connectivity. In scenarios where network availability is inconsistent, this can help ensure continuous operation. Implementations described can lower latency by, e.g., processing data locally which can provide faster response times as the data does not need to travel to another processor (e.g., central server) for processing. This can be helpful in applications requiring real-time responses, such as autonomous vehicles or industrial automation. Implementations described can provide real-time analytics. For example, on-sensor processing can enable real-time analytics without delay for applications requiring quick or immediate data analysis, such as in environmental monitoring or security systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example processing system.

FIG. 2 shows an example pixel.

FIG. 3 shows waveforms generated in a circuit using different weighting values.

FIG. 4 shows a relationship between power consumption and three metrics, including illuminance, temperature, and mismatch.

FIG. 5 shows an example analog-to-digital (ADC) circuitry structure.

FIG. 6 shows an example 32×32 pixel array.

FIG. 7 shows an example of two different image frames processed by architecture described in this document.

FIG. 8 shows example steps of convolution.

FIG. 9 shows an example of a Convolution-in-Pixel approach using a 3×3 filter size and 9×9 pixel array as input.

FIG. 10 is a flowchart of a first example process for improving image processing.

FIG. 11 is a flowchart of a second example process for improving image processing.

FIG. 12 is a flowchart of a third example process for improving image processing.

Like reference numbers and designations in the various drawings indicate like elements

### DETAILED DESCRIPTION

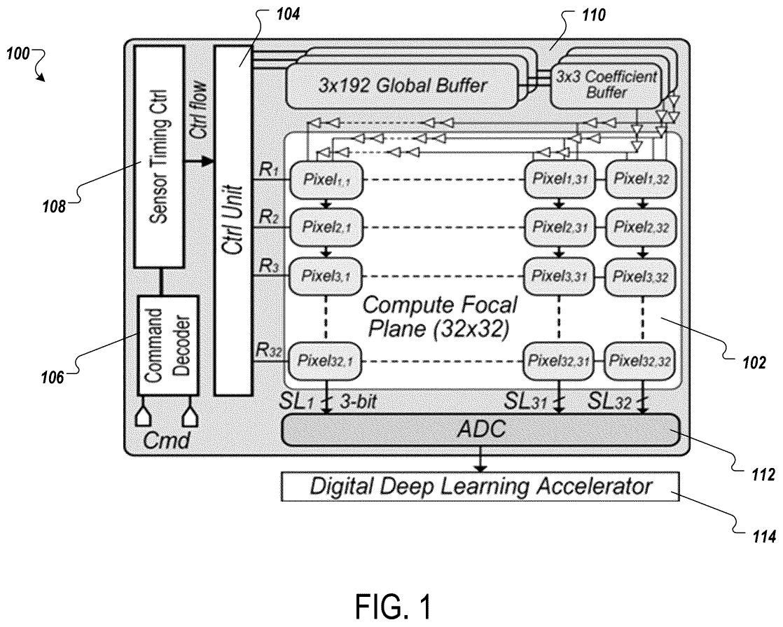

FIG. 1 shows an example processing system 100. The system 100 can include features for event or object detection using input sensor data—e.g., data from one or more image sensors. The processing system 100 can include an AppCiP architecture as described in this document.

The processing system 100 includes a compute focal plane (CFP) array 102, row and column controllers (Ctrl) 104, a command decoder 106, sensor timing control 108, a memory unit 110, and an analog-to-digital converter (ADC) 112. The system 100 can include a learning accelerator 114. In some cases, the CFP array 102 includes 32 by 32 pixels. In some cases, the memory unit 110 includes 2 kilobytes of memory. In some cases, each pixel of the CFP array 102 includes a sensor and three compute ad-ons (CAs) to realize an integrated sensing and processing scheme. The 2-KB storage can include one or more buffers, e.g., three global buffers (GBs) and three smaller units, coefficient buffers (CBs).

The memory unit 110 can store coefficients or weight representatives. In some cases, each CB is connected to a number of pixels—e.g., 300. To help ensure correct functionality a buffer, e.g., two inverters, can be positioned between CBs and every column of the CFP array 102.

In some implementations, the system 100 is capable of operating in two modes. For example, the system 100 can operate in event-detection or object-detection mode, targeting low-power but high classification accuracy image processing applications.

In some cases, the specific portions of weight coefficients are first loaded from GBs into the CBs of the memory unit 110 as weight representatives. The weight representatives can be connected to a subset of pixels, e.g., only 100 pixels out of 1024. In response to an object, such as a moving object, being detected, the system 100 can switch to object- detection mode. Switching to object-detection mode can include activating the subset of pixels not included in the subset of pixels connected to the weight representatives. For example, in the 32 pixel by 32 pixel case, all 1024 pixels can be activated in response to detecting an object and in the process of switching to the object-detection mode. Activated pixels can capture a scene. After sensor data is captured by the activated pixels, a first convolutional layer of a CNN model can be performed. In some implementations, a first set of one or more layers of the CNN model are performed in the system 100 prior to the learning accelerator 114. For example, a first layer of the CNN model can be performed in the system 100 prior to the learning accelerator 114. The system 100 can transmit the data from the first convolutional layer of the CNN to the learning accelerator 114. The learning accelerator 114 can be included on-chip with one or more elements shown in the system 100 of FIG. 1.

In some implementations, the CFP array 102 of the system 100 includes 32×32=1024 pixels. In some cases, each pixel can include a sensor with red, blue, and green photodiodes (PD) and three compute add-ons (CAs) to compute convolutions.

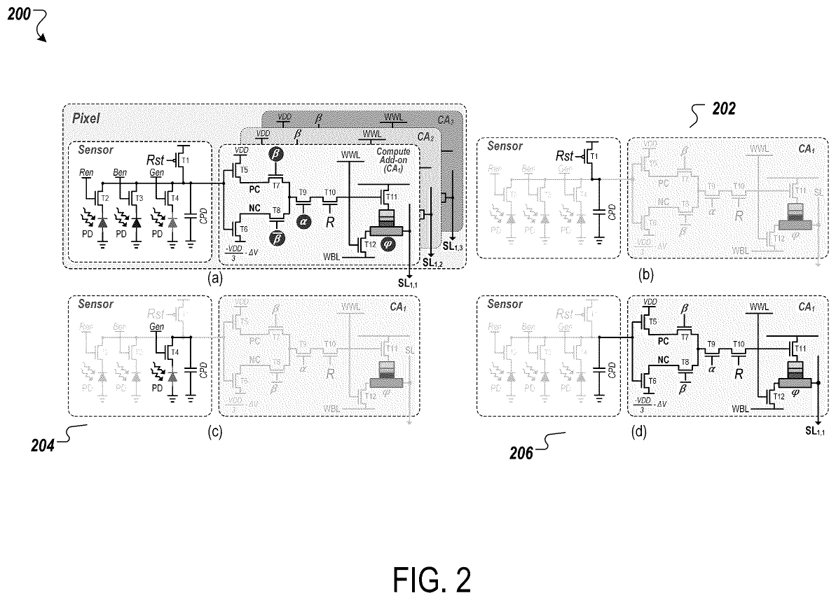

FIG. 2 shows an example pixel 200. The pixel 200 can include a sensor and three compute add-ons. FIG. 2 shows different phases including (b) pre-charge, (c) evaluation, and (d) computing.

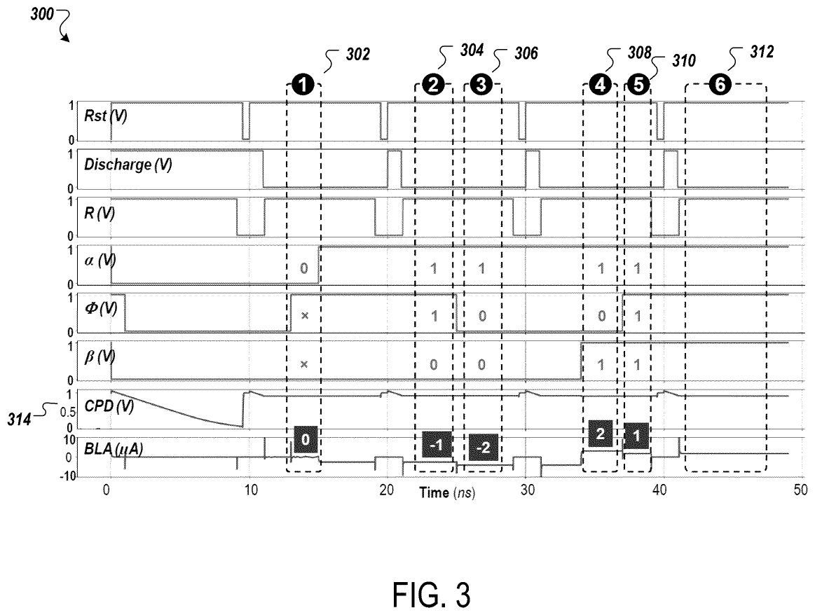

In some cases, each CA is connected to identical CBs with same weight coefficients and arrangements. The pixel 200 can enable one of the PDs connected to the C_{PD} capacitor. Signals Ren, Ben, and Gen can be determined in a pre-processing step (e.g., in the software domain) to help increase accuracy while reducing energy. A representation of different signals is shown in FIG. 3.

The remaining diodes, e.g., excluding one or more of red, blue, or green diodes shown in FIG. 2, can be grounded. In general, pixels include three fundamental phases: pre-charge, evaluation, and computing. In the pre-charge phase, C_{PD} capacitor will charge to the V_{DD} using T1 (202). Then, in an evaluating phase, C_{PD} will be discharged based on the resistance of the enabled PD (204). Finally, based on the C_{PD}'s voltage and weights coefficients (α, β, ϕ) CAs can generate multiple levels of current on the SL, e.g., SL1, 1 (206). Transistor T10 can be used for both row selection (signal R) and read operation of Spin Orbit Torque Magnetic Random-Access Memory (SOT-MRAM), which can lead to area reduction.

The pixel 200 can be simulated using 45 nm Complementary metal-oxide-semiconductor (CMOS) technology node under room temperature (27 degrees C.) using HSPICE. Obtained transient waveforms are shown in FIG. 3, where the inputs and outputs are depicted in green and red colors, respectively. The first 10 ns are dedicated to the system initialization phase. In AppCiP, every pixel can connect to three CBs, including different coefficient matrices, α, β, and ϕ, which are configured to generate appropriate weights shown in the table 1 below:

TABLE 1
Quinary Weights And Power Consumption,
Stored A, B, And Φ.

| α | β | ϕ | Weight | Power Consumption (μW) |
|---|---|---|---|---|
| 0 | x | x | 0 | 0.247 |
| 1 | 0 | 0 | −2 | 1.35 |
| 1 | 0 | 1 | −1 | 0.843 |
| 1 | 1 | 0 | 2 | 2.08 |
| 1 | 1 | 1 | 1 | 1.24 |

The value α is configured to generate a current flow in a pixel or not. If α is zero, it disables the pixel. The current direction, e.g., negative or positive, and the current magnitude are determined by β and ϕ, respectively. The three coefficients form five different weights ∈ {−2, −1, 0, 1, 2}. With respect to the weights, the power consumption, and functionalities are illustrated in the above table and FIG. 3.

FIG. 3 shows, α=0 and regardless of changing ϕ, injected current on BL is zero, which denotes as weight ‘0’ (302). FIG. 3 also shows −1 weight (304), −2 weight (306), 2 weight (308), and 1 weight (310. Value of V_{CPD} (314) remains unchanged where the pixel, e.g., the pixel 200, generates a constant current based on coefficients on BL (312).

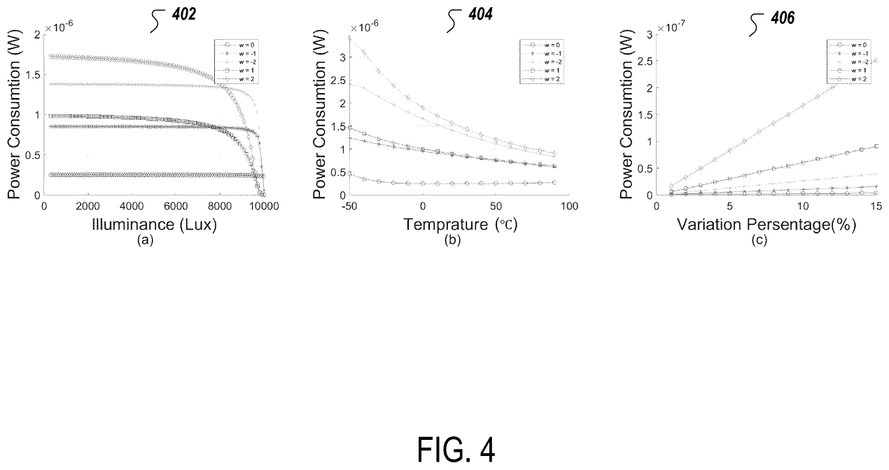

FIG. 4 shows a relationship between power consumption and three metrics, including (a) illuminance, (b) temperature, and (b) mismatch. FIG. 4 shows power consumption of a pixel versus illuminance (402). As shown, when W=‘0’, the pixel consumes lower power on average, whereas by increasing light intensity, in some cases, e.g., 10000 lux, other weights consume less power. This can happen because the reverse current of PD increases, and consequently, in the evaluation step, C_{PD} completely discharges. As a result, the pixel cannot produce any current regardless of weight values.

FIG. 4 shows temperature varying from −50° C. to 90° C. and shows a direct relationship between power and temperature (404). FIG. 4 also shows the obtained results in the presence of 15% process variation in transistor sizing for 1000 simulation runs, proving the pixel operations' correctness (406).

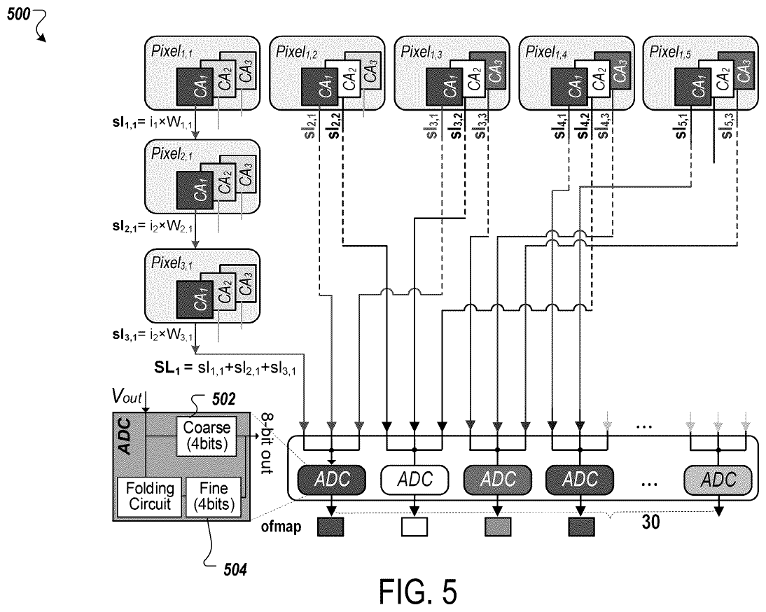

FIG. 5 shows an example ADC circuitry structure 500. The structure 500 can be configured to produce a whole row of an ofmap matrix in one cycle. The structure 500 can include a folding ADC that includes coarse and fine parts. Coarse circuit 502 can be configured for the most significant bits (MSBs). Fine circuit 504 generates the four least significant bits (LSBs). For an 8-Bit flash ADC, the structure uses 32 comparators instead of 256 comparators in non-folding ADCs.

In some cases, in object-detection mode, only 8 bits are used. In some cases, while in event-detection mode, only four MSBs are required. In this way, the architecture can save power and memory, e.g., by turning off folding or fine circuit 504. As shown in FIG. 5, columns and three rows, including three CA₁ components, are activated. The structure 500 can convert one or more input pixel values to a weighted current according to different weights, W_{1,1}, W_{2,1}, and W_{3,1}, which can be interpreted as the multiplication in DNNs. According to Kirchhoff's law, the collection of the current through each SL can represent a MAC result, I_{sum,j}=ΣᵢG_{j,i}Vᵢ, where G_{j,i} can represent conductance of a synapse connecting i^{th} to the j^{th} node. The final value can be converted to a voltage, e.g., measured using ADCs, and transmitted to a next-level near-sensor accelerator or a digital deep-learning accelerator, e.g., the learning accelerator 114 of FIG. 1.

The AppCiP architecture can offers two modes, including event-detection and object-detection modes. A mode can be chosen by the architecture automatically based on a condition. In some cases, in the object-detection mode, 100 of 1024 pixels are always ON (active). Once an event is detected, the architecture can switch to an object-detection mode with all active pixels.

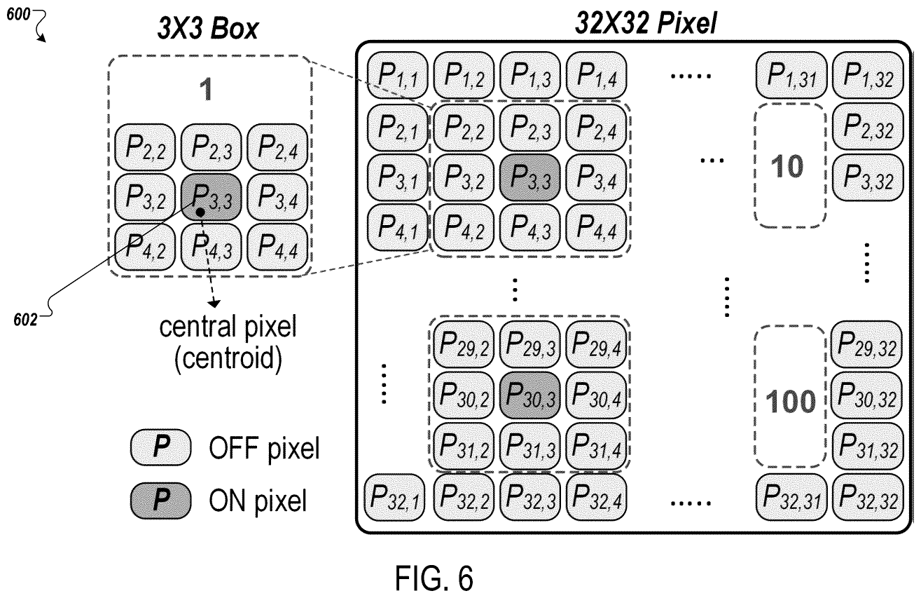

FIG. 6 shows an example 32×32 pixel array 600. The array 600 includes boxes with sets of pixels—in this case, 9 pixels of 3 by 3 in each box. A box can include one or more active pixels and one or more inactive pixels depending on modes of an architecture, e.g., the system 100 of FIG. 1. The architecture, e.g., in the system 100 of FIG. 1, can include 32×32 pixels. Pixels can be grouped in sets of 3×3, resulting in 100 boxes in total, as shown in FIG. 6.

In some implementations, central pixel 602, e.g., the centroid, of boxes is dedicated to participating in both event and object-detection modes. Other pixels can be activated in response to an event—e.g., a detection of an object resulting in switching to the object-detection mode. In some implementations, all border pixels located in a surrounding of the architecture are inactive. The a coefficient can be initialized to zero except pixels' indices (x, y), where x, y ∈ {3n, 1≤n≤10}, e.g., only centroids affect ADC inputs. This operation can be performed by adjusting the 3, 3 value of pixel 602. To optimize power consumption and based on Table 1, other coefficients, β, and ϕ, can be set to ‘0’ and ‘1’, respectively, to produce a weight ‘−1’—other weights can be set using other values.

The operation principle of the event-detection mode can be illustrated in steps including, e.g., read, calculation (compare), and activation. An example of such steps are presented in the Algorithm 1, below:

Algorithm 1: Sample Event-Detection In-Pixel Algorithm (DIPA).

1: Input: 32 × 32 pixel array
2: Output: Activated Boxes
3: procedure DIPA
4: pixel values ← Read (central pixels)
5: turn on list = [ ]
6: for i ← 0 to |pixel values|
7: if pixel values [i][7:4]/= old pixel values [i][7:4]
8: count ++
9: if count ≥ threshold
10: turn on_all_pixel( ) [symbol] Object-Detection
mode is activated.

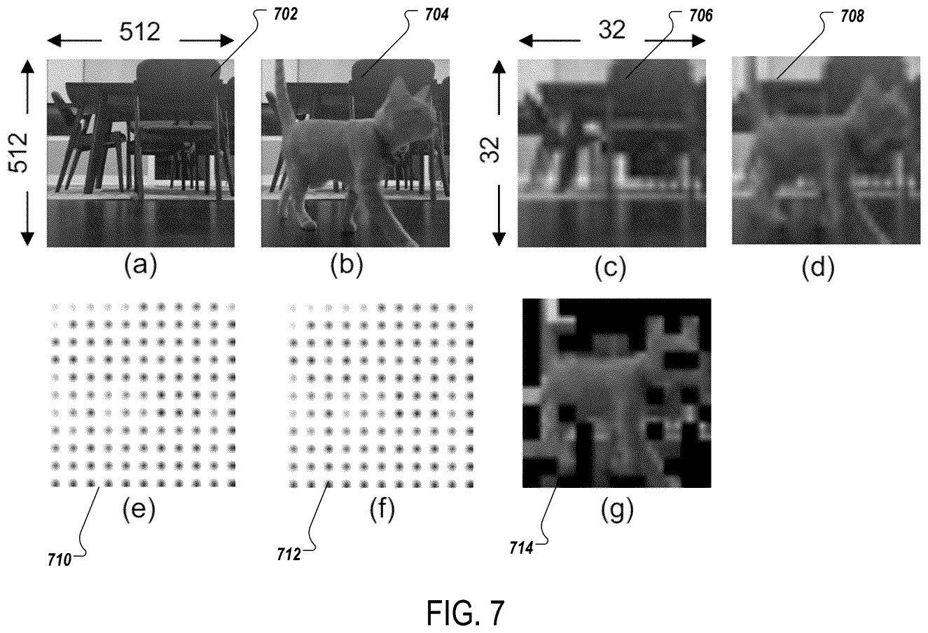

In reading step (line 4), only a centroid of each box is activated. For example, two original images are shown in FIG. 7 depicting a non-event (702) and an event (704).

FIG. 7 shows two different image frames processed by the architecture described in this document. The resized versions of (702) and (704) are represented in (706) and (708), respectively. When a subset of pixels are activated, a more sparse set of pixels can illustrate a scene (710 and 712). Active boxes regarding a defined threshold after comparing frames (710 and 712) can be represented using black for inactive pixels (714). For example, a box that differs by more than four bits can be activated.

The architecture, e.g., the system 100 of FIG, 1, can generate a 32×32 pixel version of each, e.g., a non-event 32×32 pixel version (706) and an even 32×32 pixel version (708). Before an object is detected, e.g, in event detection mode, the architecture described in this document can generate centroid images from centroid pixels in groups of pixels in a pixel array, such as the CFP array 102 or the array 600 (710) and (712). Centroid images from activated centroid pixels, such as pixel 602, can include only 10×10=100 active pixels rather than 32×32=1024 pixels—other values can be used in cases where more pixels are included in an architecture.

This almost 90% reduction in activated pixels considerably reduces overall power consumption. In the calculation step (lines 6-8 of Algorithm 1), the centroid value in a row is measured using the ADCs. Afterward, an index of the activated row can be increased by three, while AppCip can handle three rows simultaneously. Nonetheless, in this step, it is not necessary to use all 8-bit of ADC, and the architecture can approximately detect an event.

In some cases, only four bits of every centroid are measured and compared with the previous pixel's value leveraging the ADC, e.g., shown in FIG. 5. If two values are equal, interpreted as the inactivity, otherwise interpreted as an activity or event occurrence. In this example for two inputs images, all boxes with inactivity turned to black (714).

In some cases, the detection method includes a reconfigurable threshold embedded in the system that indicates a maximum number of active regions, e.g., adjusting in line 9. If a number of active areas is equal to or greater than the threshold, the system, e.g., the system 100, can switch, in response, to the object-detection mode. A large threshold value can generally lead to more power savings but at the cost of accuracy degradation. In some cases, values of old pixel values are updated only when the system switches to the event-detection mode, e.g., back from object-detection mode.

In response to detecting an event, the system 100 can turn on one or more pixels—e.g., all pixels. The AppCiP, e.g., included in the system 100, can switch to object-detection mode. In object-detection mode, the C_{PD} capacitor is initialized to the fully-charged state by setting Rst=‘low’, (see 202 of FIG. 2). During an evaluation cycle, by turning off T1, the Ctrl Unit can activate one—e.g., only one—of the (R/G/B) en signals to detect light intensity. For example, in 204 of FIG. 2, by activating T4, the pixel detects only green intensity of an area. After each pixel evaluates a target light intensity, T4 can be turned off, and by activating T10 using the R signal, a positive or negative current can be applied to the SL (206). Here, β acts like a multiplexer to choose a positive or negative current, a acts like a switch to disconnect or connect the current to SL, and ϕ acts like a resistor to adjust injected current to SL.

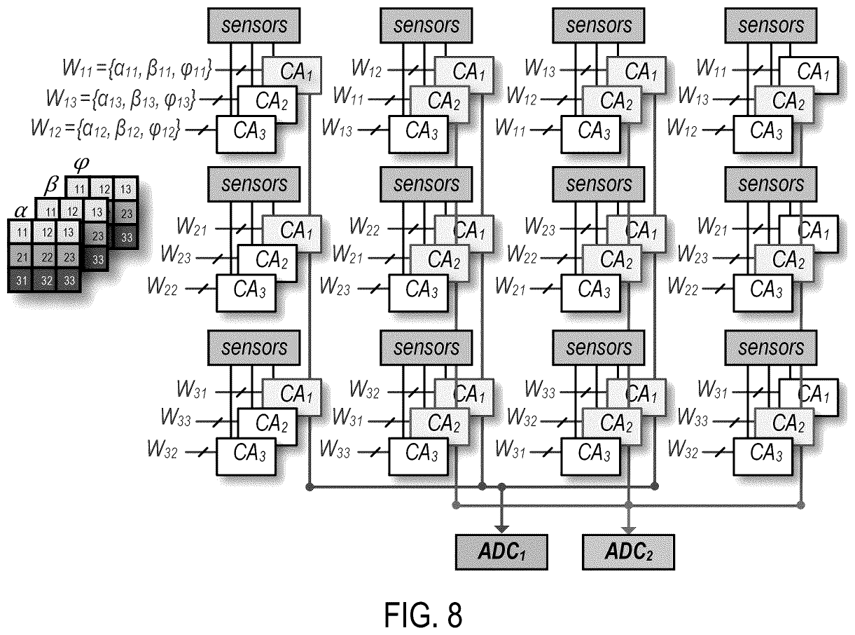

FIG. 8 shows example steps of convolution. The example steps are configured for a 3×4 array with hardwired connections propagating various weight arrangements. In FIG. 8, all three rows are activated, resulting in all CAs with the same index, e.g., CA₁, in a common column being connected together and generating a current on the SL. Different CAs in different columns can be merged to implement a single-cycle MAC operation.

In some implementations, an approximate convolution-in-pixel (CIP) is performed by the architecture described in this document. For example, the system 100 can perform an approximate CIP. The App-CiP can perform a 1st-layer's convolution operations in an analog domain in response to capturing an image that increases MACs throughput, and decreases the ADC overheads. The operation principle of the Convolution-in-Pixel is shown in the example Algorithm 2.

Algorithm 2: Convolution-in-Pixel (CiP) Algorithm.

1: Input: Captured image via 32 × 32 pixel array
2: K: Number of filters [symbol] Filters' 3D-dimension: K × 3 × 3
3: WB: A 3 × 3 filter
4: Output: 1st-layer convolution [symbol] Produces the complete ofmap
5: procedure CIP
6: for k ← 1 to K [symbol] WS dataflow
7: offset= 0
8: Label:L1
9: for h ← 2 + offset to (H − 1) with step= 3 [symbol] H = 32
10: for r ← 1 to R [symbol] R = 3
11: Active_Row (h-1, h, h+1)
12: parallel for s ← 1 to S [symbol] S = 3
13: Calculate_CONV ( )
14: offset = offset + 1
15: if offset < 3
16: Shift Down (WB↓)
17: goto: L1
18: Load_New_Weight (GB ⇒ WB)

One or more capacitors within the 32×32 pixel array can be written regarding the light intensity of a target image. In this way, AppCip can implement input stationary (IS) dataflow that minimizes a reuse distance of input feature maps (ifmaps), maximizing the convolutional and ifmap data reuse. On the other hand and to increase efficiency by reducing data movement overhead, AppCiP architecture can include coefficient buffers (CBs), which can be used to store a 3×3 filter using three α, β, and ϕ coefficient matrices with the capability of shifting values down to implement stride.

The stride window can be 1. The loop with variable K, which can index filter weights, can be used in the outermost loop, Algorithm 2 (line 6). In this way, the loaded weights in WBs can be fully exploited before replacement with a new filter, leading to a weight stationary (WS) dataflow. Algorithm 2 can activate three rows (line 11) for all three CAs and simultaneously perform convolutions for all 32×3 columns, producing all the outputs for a single row of output feature map (ofmap) in a single cycle. Using the parallelism of AppCip, all possible horizontal stride movements can be considered without shift operation. Weights can be shifted down (line 16), and the process can be repeated for shifted weights.

Since the connections between WB's blocks and 3×1024 CAs' elements can be hardwired, different weights of a R×S filter can be unicast to a group of nine pixels in a CA, whereas broadcast to other groups of pixels in different CAs. The spatial dimensions of a filter can be represented by R and S, height and width, respectively. This parallel implementation can allow AppCiP to compute R×S×Q MAC operations (e.g., 270) in only one clock cycle, where Q is the width of the ofmap. To maximize weight data reuse, the next three rows of CAs can be enabled before replacing a filter or shifting the weights, and the convolutions using the same weights can be performed (line 9 of Algorithm 2). This approach can continue until all CA rows are visited, which takes at most x=[H 3] cycles, where H is the height of ifmap, e.g., 32.

After x cycles, weight values can be shifted down (line 16 of Algorithm 2), a new sequence of three rows can be activated, and the procedure goes to the label L1 (line 8). The same operations and steps can be carried out, and then a final downshift can be performed after x cycles. The total number of required cycles is P, where P is the height of the ofmap, e.g., 30.

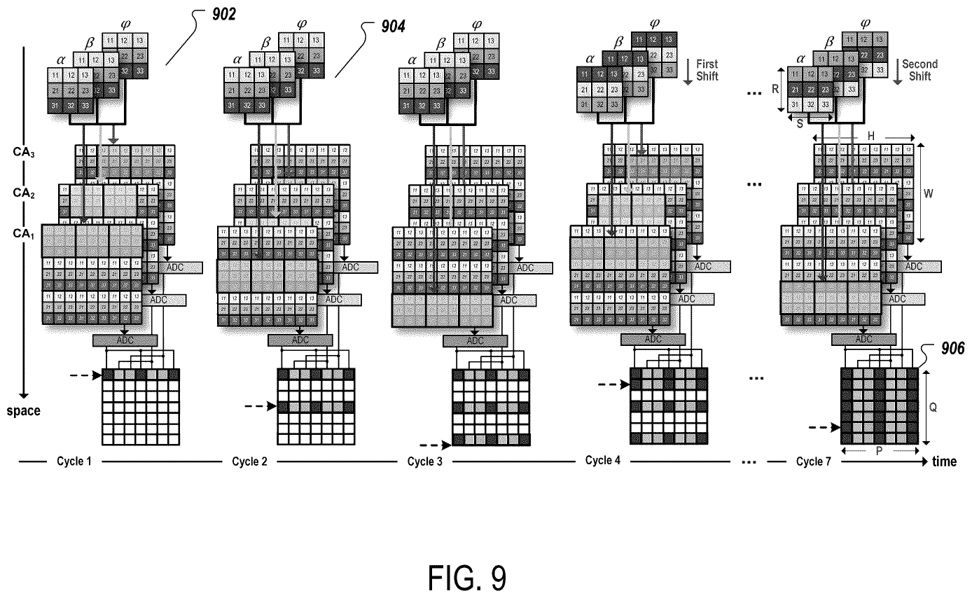

FIG. 9 shows an example of a Convolution-in-Pixel approach using a 3×3 filter size and 9×9 pixel array as input. The approach can take seven cycles to generate the 7×7 ofmap matrix. The sizes of filters and ifmaps can be 3×3 and 9×9, respectively. Because of stride 1, the ofmap size can be 7×7.

In Cycle 1, the first three rows of each CA are activated, and the loaded weights to the buffers are applied to perform convolutions (902). Due to the AppCiP structure, all the seven elements in the first row of the ofmap can be generated in one cycle. In the next cycle (2), the next three rows of CAs are enabled while the same weights are applied (904). In this cycle, the third row of ofmap is produced. The identical steps are taken in Cycle 3. Whereas in Cycle 4, the first shift is applied to the weights to implement the stride behavior. These adjusted weights can be utilized for three cycles, 4, 5, and 6. Finally, in Cycle 7, the second and final downshift is performed, and the final row of the ofmap 906 is created. AppCip is capable of performing 3×3×7=63 MAC operations in a single cycle, and the total required cycles to do 441 MACs are seven cycles.

An integrated sensing and processing architecture—referred to as AppCiP and, e.g., included in the system 100 of FIG. 1—can efficiently perform 1st-layer convolution operation of CNN. AppCiP, can include an always on intelligent visual perception architecture and can operate in event and object-detection modes. In response to detecting a moving object, the AppCiP can be configured to switch to the object-detection mode to capture one or more images. The AppCiP capabilities, including filter channel pruning and parallel analog convolutions, can help reduce power consumption and latency—when compared with different architectures on different CNN workloads—while achieving comparable accuracy results compared to an FP baseline. The AppCiP can achieve a frame rate of 3000 and an efficiency of ˜4.12 TOp/s/W. Using techniques described in this document, the architecture can enable only one of blue, red, green, or other color frequencies of a sensor simultaneously. Therefore, 66% of power saving can be achieved—e.g., over other image processing techniques. Moreover, the accuracy obtained by using only one channel can be improved when compared to using RGB inputs. A process can include training which can be performed offline. Suitable color implementations can be determined and used for training in target applications. In some cases, the AppCiP can be deployed—e.g., in hardware similar to the system 100 of FIG. 1—after training.

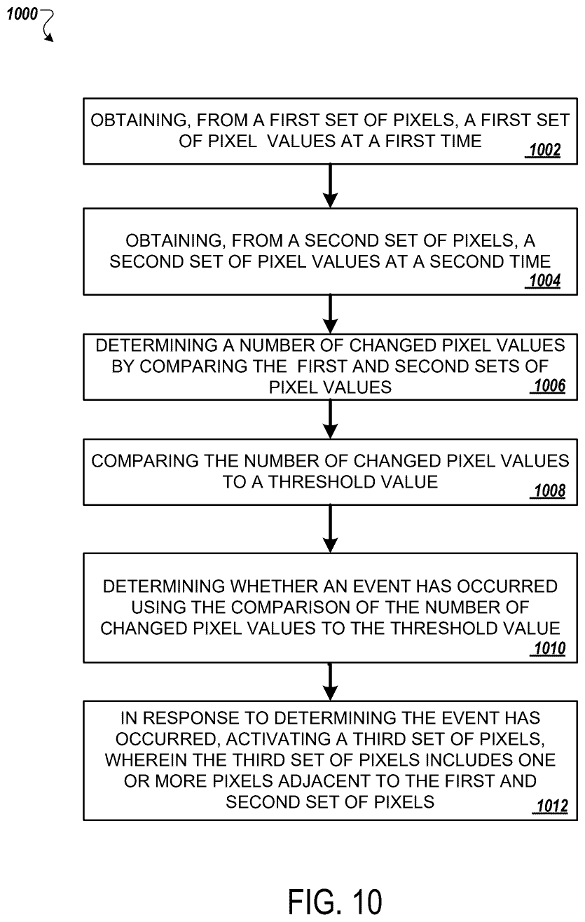

FIG. 10 is a flowchart of an example process 1000 for improving image processing. For convenience, the process 1000 will be described as being performed by a system of one or more computers or configured architectures, located in one or more locations, and programmed or configured appropriately in accordance with this specification. For example, a processing system, e.g., the processing system 100 of FIG. 1, appropriately configured, can perform the process 1000. In some implementations, aspects of process 1000 can be performed in Algorithm 1.

The process 1000 includes obtaining, from a first set of pixels, a first set of pixel values at a first time (1002). For example, the first set of pixels can include one or more pixels in the CFP array 102 of FIG. 1. In some implementations, the first set of pixels can include central pixels—e.g., the central pixel 602 of FIG. 6.

The process 1000 includes obtaining, from a second set of pixels, a second set of pixel values at a second time (1004). For example, the second set of pixels can include one or more pixels in the CFP array 102 of FIG. 1. The first set of pixels can be the same or different from the second set of pixels.

The process 1000 includes determining a number of changed pixel values by comparing the first and second sets of pixel values (1006). For example, the processing system 100 can compare a subset of bits, e.g., bits 4-7, within one or more bytes describing each of the first and second sets of pixel values. In some cases, comparing only the subset of bits helps to reduce power usage.

The process 1000 includes comparing the number of changed pixel values to a threshold value (1008). For example, the processing system 100 can compare a count of changed pixels to a threshold—e.g., line 9 of Algorithm 1.

The process 1000 includes determining whether an event has occurred using the comparison of the number of changed pixel values to the threshold value (1010). For example, the processing system 100 can determine an even has occurred—e.g., an object has been detected or an object has changed characteristics.

The process 1000 includes in response to determining the event has occurred, activating a third set of pixels, wherein the third set of pixels includes one or more pixels adjacent to the first and second set of pixels (1012). For example, the processing system 100 can turn on pixels surrounding the central pixel 602 of FIG. 6.

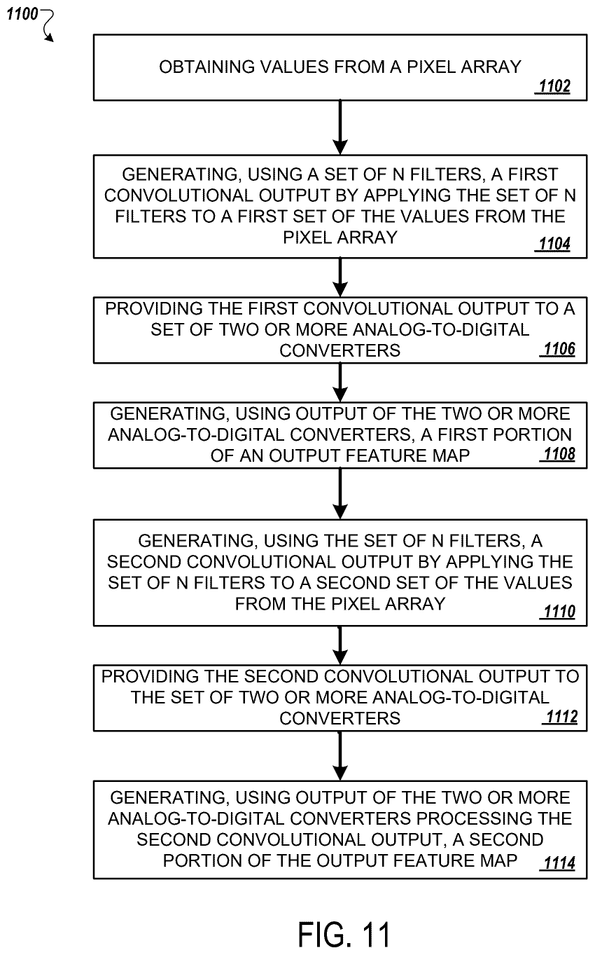

FIG. 11 is a flowchart of an example process 1100 for improving image processing. For convenience, the process 1100 will be described as being performed by a system of one or more computers or configured architectures, located in one or more locations, and programmed or configured appropriately in accordance with this specification. For example, a processing system, e.g., the processing system 100 of FIG. 1, appropriately configured, can perform the process 1000. In some implementations, aspects of process 1100 can be performed in Algorithm 2.

The process 1100 includes obtaining values from a pixel array (1102). For example, the first set of pixels can include one or more pixels in the CFP array 102 of FIG. 1.

The process 1100 includes generating, using a set of N filters, a first convolutional output by applying the set of N filters to a first set of the values from the pixel array (1104). For example, filters α, β, and ϕ shown in FIG. 9 can be used as a set of N filters where N is equal to 3.

The process 1100 includes providing the first convolutional output to a set of two or more analog-to-digital converters (1106). For example, the set of three ADCs shown in FIG. 9 can be an example set of two or more analog-to-digital converters. In some cases, using two or more ADCs can enable parallelism of applying one or more filters also referred to as weights. In FIG. 9, using a set of three ADC and weight matrices can be used to get a first output of an output feature map in parallel—thereby reducing a generation time of that map.

The process 1100 includes generating, using output of the two or more analog-to-digital converters, a first portion of an output feature map (1108). For example, the first portion of the output feature map can include the first row shown after cycle 1 in FIG. 9.

The process 1100 includes generating, using the set of N filters, a second convolutional output by applying the set of N filters to a second set of the values from the pixel array (1110). For example, in a next cycle (904) weights α, β, and ϕ—e.g., the same as used to generate the first convolutional output—can be applied to generate output for the ADCs shown in FIG. 9.

The process 1100 includes providing the second convolutional output to the set of two or more analog-to-digital converters (1112). For example, the set of three ADCs shown in FIG. 9 can be an example set of two or more analog-to-digital converters.

The process 1100 includes generating, using output of the two or more analog-to-digital converters processing the second convolutional output, a second portion of the output feature map (1114). For example, the second portion of the output feature map can include the fourth row shown after cycle 2 in FIG. 9.

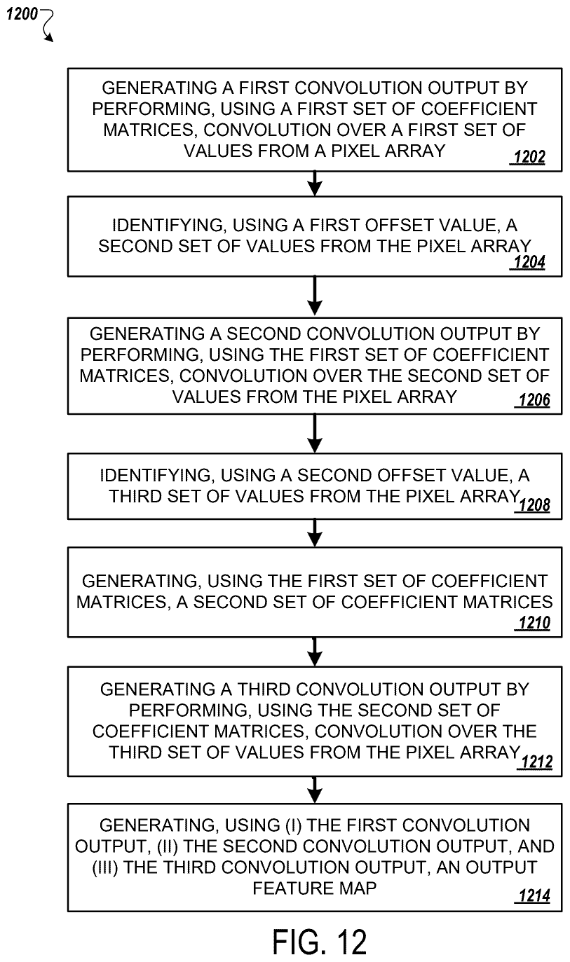

FIG. 12 is a flowchart of an example process 1200 for improving image processing. For convenience, the process 1200 will be described as being performed by a system of one or more computers or configured architectures, located in one or more locations, and programmed or configured appropriately in accordance with this specification. For example, a processing system, e.g., the processing system 100 of FIG. 1, appropriately configured, can perform the process 1200. In some implementations, aspects of process 1200 can be performed in Algorithm 2.

The process 1200 includes generating a first convolution output by performing, using a first set of coefficient matrices, convolution over a first set of values from a pixel array (1202). For example, the first set of coefficient matrices can include filters α, β, and ϕ shown in FIG. 9. The first set of values from a pixel array can include a first 3 rows shown in FIG. 9—e.g., cycle 1.

The process 1200 includes identifying, using a first offset value, a second set of values from the pixel array (1204). For example, the second set of values from a pixel array can include a second 3 rows shown in FIG. 9—e.g., cycle 2.

The process 1200 includes generating a second convolution output by performing, using the first set of coefficient matrices, convolution over the second set of values from the pixel array (1206). For example, the first set of coefficient matrices can include filters α, β, and ϕ shown in FIG. 9. The second set of values from a pixel array can include rows 4-6 shown in FIG. 9—e.g., cycle 2.

The process 1200 includes identifying, using a second offset value, a third set of values from the pixel array (1208). For example, the pixel values highlighted in cycle 4 of FIG. 9.

The process 1200 includes generating, using the first set of coefficient matrices, a second set of coefficient matrices (1210). For example, in cycle 4 in FIG. 9, the filters α, β, and ϕ are shifted—e.g., generating a second set of coefficient matrices.

The process 1200 includes generating a third convolution output by performing, using the second set of coefficient matrices, convolution over the third set of values from the pixel array (1212). For example, the second row of the output feature map—e.g., ofmap 906—can be generated using a shifted set of α, β, and ϕ.

The process 1200 includes generating, using (i) the first convolution output, (ii) the second convolution output, and (iii) the third convolution output, an output feature map (1214). For example, generating the ofmap 906 shown in FIG. 9.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results In some cases, multitasking and parallel processing may be advantageous.

1. A method comprising:
obtaining, from a first set of pixels, a first set of pixel values at a first time;
obtaining, from a second set of pixels, a second set of pixel values at a second time;
determining a number of changed pixel values by comparing the first and second sets of pixel values;
comparing the number of changed pixel values to a threshold value;
determining whether an event has occurred using the comparison of the number of changed pixel values to the threshold value; and
in response to determining the event has occurred, activating a third set of pixels, wherein the third set of pixels includes one or more pixels adjacent to the first and second set of pixels.

2. The method of claim 1, wherein the first and second set of pixels are comprised of centroid pixels, wherein each of the centroid pixels are adjacent to pixels not included in the first or second set of pixels.

3. The method of claim 1, wherein the first and second set of pixels are the same.

4. The method of claim 1, wherein pixels of the first and second set of pixels include a sensor and one or more compute add-ons, wherein (i) each of the one or more compute add-ons include a plurality of transistors and (ii) the sensor includes a photodiode.

5. The method of claim 4, wherein photodiodes of the sensors in the pixels of the first and second set of pixels include activated photodiodes and non-activated photodiodes.

6. The method of claim 5, wherein the only activated photodiode detects radiation in a frequency range corresponding to the color green.

7. The method of claim 6, wherein the photodiodes include a red and blue photodiode that are non-activated.

8. The method of claim 4, wherein the plurality of transistors of the pixels are configured to generate multiple levels of current using voltage from a capacitor connected to the photodiode and a set of one or more weighted values.

9. The method of claim 1, wherein comparing the first and send sets of pixel values comprise:
comparing a subset of one or more bits from one or more bits representing a first value of the first set of pixel values and a subset of one or more bits from one or more bits representing a second value of the second set of pixel values.

10. The method of claim 9, wherein comparing the subset of bits representing the first value and the subset of bits representing the second value comprises:
comparing three bits representing the first value and three bits representing the second value.

11. A method comprising:
obtaining values from a pixel array;
generating, using a set of N filters, a first convolutional output by applying the set of N filters to a first set of the values from the pixel array;
providing the first convolutional output to a set of two or more analog-to-digital converters;
generating, using output of the two or more analog-to-digital converters, a first portion of an output feature map;
generating, using the set of N filters, a second convolutional output by applying the set of N filters to a second set of the values from the pixel array;
providing the second convolutional output to the set of two or more analog-to-digital converters; and
generating, using output of the two or more analog-to-digital converters processing the second convolutional output, a second portion of the output feature map.

12. The method of claim 11, wherein N is 3.

13. The method of claim 11, wherein the pixel array includes an array of 32 pixels by 32 pixels.

14. The method of claim 11, wherein the first portion of the output feature map is a row or column of the output feature map.

15. The method of claim 11, wherein the first portion of the output feature map and the second portion of the output feature map are separated by N-1 rows or columns.

16. The method of claim 11, wherein the first set of the values from the pixel array and the second set of the values from the pixel array are separated by N-1 rows or columns.

17. The method of claim 11, wherein the set of N filters include one or more coefficient matrices.

18. The method of claim 17, wherein the set of N filters include three 3×3 coefficient matrices.

19. A method comprising:
generating a first convolution output by performing, using a first set of coefficient matrices, convolution over a first set of values from a pixel array;
identifying, using a first offset value, a second set of values from the pixel array;
generating a second convolution output by performing, using the first set of coefficient matrices, convolution over the second set of values from the pixel array;
identifying, using a second offset value, a third set of values from the pixel array;
generating, using the first set of coefficient matrices, a second set of coefficient matrices;
generating a third convolution output by performing, using the second set of coefficient matrices, convolution over the third set of values from the pixel array; and
generating, using (i) the first convolution output, (ii) the second convolution output, and (iii) the third convolution output, an output feature map.

20. The method of claim 19, wherein performing the convolution over the first set of values from the pixel array is performed in a single compute cycle.

21. A system comprising:
a focal plane array;
a group of one or more buffers connected to the focal plane array;
the focal plane array comprising a plurality of pixels, wherein each pixel of the plurality of pixels includes a sensor and one or more compute add-ons, wherein (i) each of the one or more compute add-ons include a plurality of transistors and (ii) the sensor includes a photodiode; and
wherein the plurality of transistors are configured to generate multiple levels of current using voltage from a capacitor connected to the photodiode and a set of one or more weighted values.

22. A system comprising one or more computers and one or more storage devices on which are stored instructions that are operable, when executed by the one or more computers, to cause the one or more computers to perform the method of claim 1.

23. One or more computer storage media encoded with instructions that, when executed by one or more computers, cause the one or more computers to perform the method of claim 1.
